(19) United States
(12) Patent Application Publication
(10) Pub. No.: US 2020/0406597 A1
(43) Pub. Date: Dec. 31, 2020

(54) WINDOW AND DISPLAY DEVICE COMPRISING THE SAME

(71) Applicant: Samsung Display Co., LTD., Yongin-si (KR)

(72) Inventors: Ho Lim, Suwon-si (KR); Jae Jin Lyu, Yongin-si (KR); Ka Eun Kim, Seongnam-si (KR); Tae Min Kim, Hwaseong-si (KR); Duck Jong Suh, Gwangmyeong-si (KR); Bong Sung Seo, Suwon-si (KR); Seul Gee Lee, Seoul (KR)

(21) Appl. No.: 16/828,349

(22) Filed: Mar. 24, 2020

(30) Foreign Application Priority Data
Jun. 26, 2019 (KR) 10-2019-0076539

(51) Int. Cl. B32B 27/40; B32B 27/30; B32B 27/08; B32B 7/12

(52) U.S. Cl. CPC B32B 27/40; B32B 27/308; B32B 27/08; B32B 7/12; B32B 2255/24; B32B 2307/546; B32B 2307/536; B32B 2255/10; B32B 2457/208

(57) ABSTRACT

A window for a display includes a first layer including polyurethane, a second layer disposed on the first layer and the second layer having a Young's modulus in a range of about 3 GPa to about 10 GPa, a third layer disposed on the second layer, and a hard coating layer disposed on the third layer.

### CROSS REFERENCE TO RELATED APPLICATION

This application claims priority from and the benefit of Korean Patent Application No. 10-2019-0076539, filed on Jun. 26, 2019, which is hereby incorporated by reference for all purposes as if fully set forth herein.

### BACKGROUND

### Field

Exemplary implementations of the invention relate generally to a window and a display device including the same.

### Discussion of the Background

Recently, electronic devices that are bent or folded have been actively developed. Such a flexible electronic device includes an electronic panel such as a flexible display panel or a flexible touch panel, and various external members. The external members each have different functions. The external members are disposed on at least one of a first side surface and a second side surface of the electronic device.

The external members are curved, bent, or folded along with the electronic device. The external members are required to have a relatively flexible character to be curved, bent, or folded. In the case of having a flexible characteristic, the reliability of stress caused by the bending may be improved, but the reliability of impact may be reduced. The above information disclosed in this Background section is only for understanding of the background of the inventive concepts, and, therefore, it may contain information that does not constitute prior art.

### SUMMARY

Applicant discovered that arranging various layers of a window for a foldable display device with specifically chosen properties provides an improved balance between flexibility and resistance to impacts.

Windows and display devices with windows constructed according to the principles and exemplary implementations of the invention are capable of being curved, bent or folded, while having high elasticity, an impact absorbing property, and abrasion resistance. Accordingly, display devices constructed according to the principles and exemplary implementations of the invention may have both flexibility and robustness against external impact. Exemplary embodiments have been made in an effort to provide a window having the above-described characteristics.

Additional features of the inventive concepts will be set forth in the description which follows, and in part will be apparent from the description, or may be learned by practice of the inventive concepts.

According to one aspect of the invention, a window for a display device includes: a first layer including polyurethane; a second layer disposed on the first layer and the second layer having a Young's modulus in a range of about 3 GPa to about 10 GPa; a third layer disposed on the second layer; and a hard coating layer disposed on the third layer.

The first layer may have a thickness of about 50 μm to about 400 μm.

In one exemplary embodiment of the invention, the window may further include an adhesive layer disposed between the first layer and the second layer.

The second layer may include at least one of polyethylene terephthalate, polyimide, polymethylmethacrylate, polycarbonate, polyethylenimine, polyphenylene sulfide, polyethylene naphthalate, and aramid.

The third layer may have a Young's modulus between about 1 GPa and about 10 GPa, and may have a transmittance of about 90% or more for light in a visible wavelength band.

The third layer may include at least one of a photocurable acrylate, urethane acrylate, and a POSS compound (polyhedral oligomeric silsesquioxane compound).

The third layer may have a thickness of about 30 μm to about 100 μm.

The hard coating layer may have a pencil hardness of about 4H or more and a transmittance of about 90% or more for light in a visible wavelength band.

The hard coating layer may include at least one of compounds represented by Chemical Formula 1 to Chemical Formula 15:

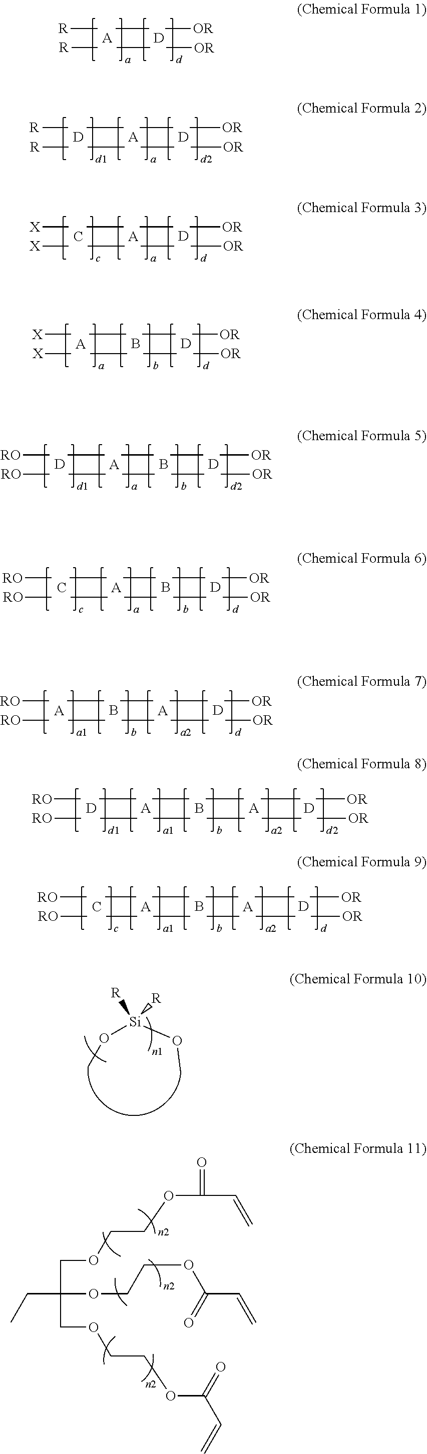

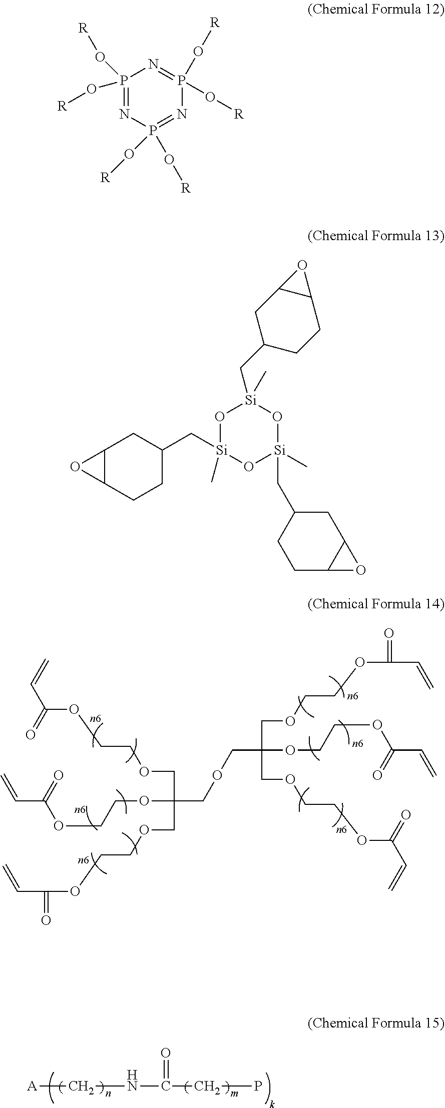

wherein, in Chemical Formula 1 to Chemical Formula 9, A indicates

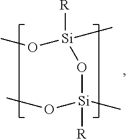

B indicates

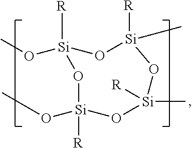

C indicates

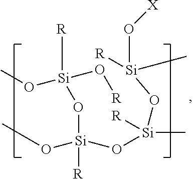

D indicates

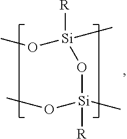

X independently indicates R or —[(SiO_{3/2}R)₂ₙ₊₄O], and R independently indicates hydrogen, heavy hydrogen, a halogen, an amine group, an epoxy group, a cyclohexyl epoxy group, an acrylic group, a methacrylic group, a thiol group, an isocyanate group, a nitrile group, a nitro group, a phenyl group, a C1 to C12 alkyl group, a C2-C12 alkenyl group, a C1-C40 alkoxy group, a C3-C12 cycloalkyl group, a C3-C12 heterocycloalkyl group, a C6-C12 aryl group, a C3-C12 heteroaryl group, a C3 to C12 aralkyl group, a C3 to C12 aryloxy group, and a C3 to C12 arylcyol group, wherein the phenyl group includes a substituted or unsubstituted hydrogen, heavy hydrogen, a halogen, an amine group, an epoxy group, a cyclohexyl epoxy group, an acryl group, a methacryl, a thiol group, an isocyanate group, a nitrile group, or a nitro group, and each of a, a1, a2, b, c, d, d1, and d2 indicates an integer between 1 and 1000;

n is an integer of 1 to 100;

n1 in Chemical Formula 10 indicates an integer between 1 and 20, n2 in Chemical Formula 11 indicates an integer between 1 and 5, and R in Chemical Formulas 10 and 12 indicates any one selected from among

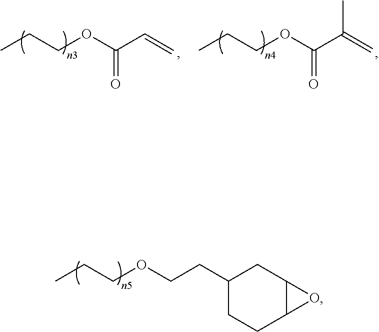

each of n3, n4, and n5 in R indicates an integer between 1 and 20, and n6 in Chemical Formula 14 indicates an integer between 1 and 20; and

in Chemical Formula 15, each of k, n, and m indicates an integer between 1 and 12, A indicates an aliphatic compound, an aromatic compound, a condensed ring compound, a linear hydrocarbon compound, or a branched hydrocarbon compound, and P includes one of an acrylate group, a methacrylate group, an epoxy group, and a vinyl group.

According to another aspect of the invention, a window for a display device includes: a first layer having a hardness of about 0.2 GPa or less and a transmittance of about 90% or more for light in a visible wavelength range; a second layer having a Young's modulus in a range of about 3 GPa to about 10 GPa disposed on the first layer; a third layer disposed on the second layer; and a hard coating layer disposed on the third layer.

The first layer may include at least one of a photocurable acrylate, urethane acrylate, and a polyhedral oligomeric silsesquioxane compound.

The first layer and the second layer may directly contact each other.

According to a further aspect of the invention, a display device includes: a first layer having a transmittance for light in a visible wavelength band greater than about 90%; a second layer having a Young's modulus in a range of about 3 GPa to about 10 GPa disposed on the first layer; a third layer having a Young's modulus in a range of about 1 GPa to about 10 GPa disposed on the second layer; and a hard coating layer.

The first layer of the display device may include polyurethane.

The first layer may have a thickness of about 50 μm to about 400 μm.

The first layer may have a hardness of about 0.2 GPa or less.

The first layer may have at least one of a photocurable acrylate, urethane acrylate, and a polyhedral oligomeric silsesquioxane compound.

The first layer and the second layer of the display device may be in direct contact with each other.

The third layer of the display device may include at least one of a photocurable acrylate, urethane acrylate, and a polyhedral oligomeric silsesquioxane compound.

The hard coating layer of the display device may have a pencil hardness of about 4H or more and a transmittance of about 90% or more for light in a visible wavelength band.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a perspective view of an exemplary embodiment of a display device constructed according to principles of the invention.

FIG. 2A to FIG. 2G respectively illustrate perspective views of the display device, which is folded, bent, or rolled, illustrated in FIG. 1.

FIG. 3A illustrates a perspective view of an exemplary embodiment of a display device constructed according to principles of the invention.

FIG. 3B illustrates a cross-sectional view of an exemplary embodiment of a display device constructed according to principles of the invention.

FIG. 4A illustrates a cross-sectional view of an exemplary embodiment of a window constructed according to principles of the invention, and FIG. 4B illustrates a cross-sectional view of an exemplary embodiment of a display device with a window.

FIG. 5A illustrates a cross-sectional view of an exemplary embodiment of a window constructed according to principles of the invention, and FIG. 5B illustrates a cross-sectional view of a display device of an exemplary embodiment with a window.

FIG. 6 illustrates a cross-sectional view of an exemplary embodiment of a portion of a pixel included in a display device.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

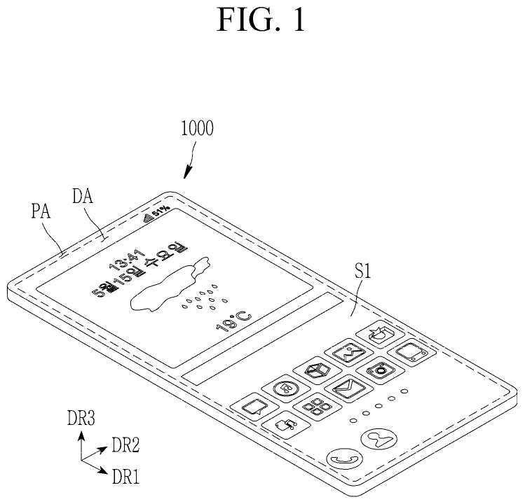

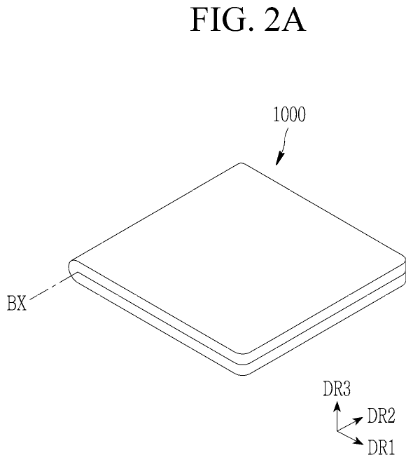

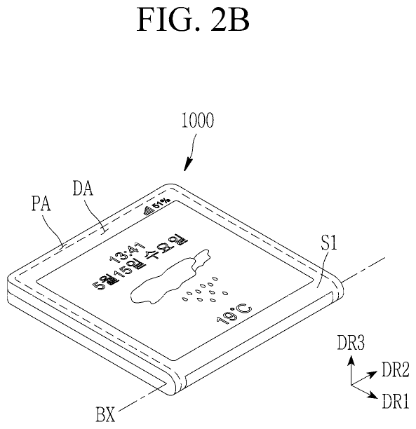

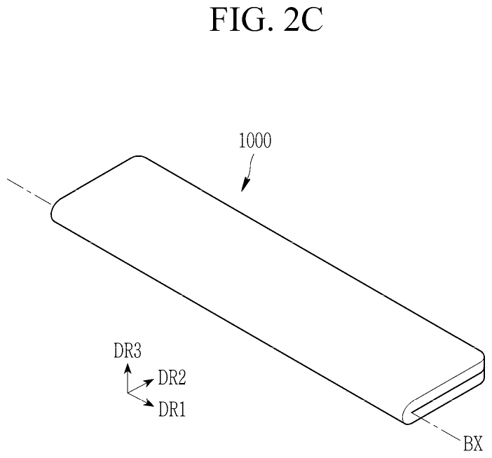

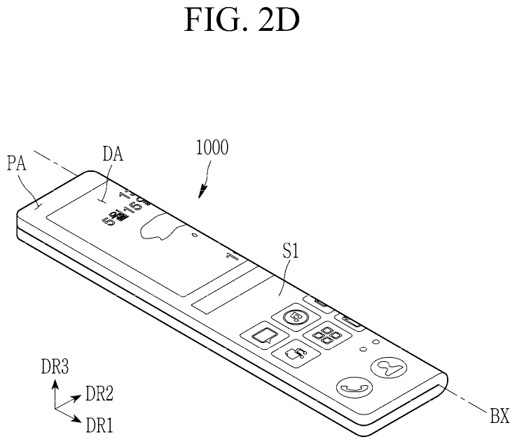

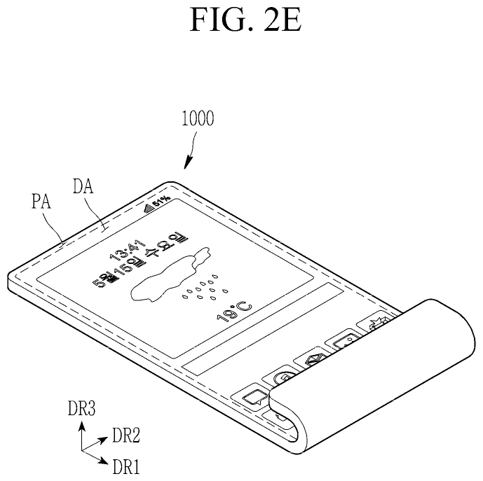

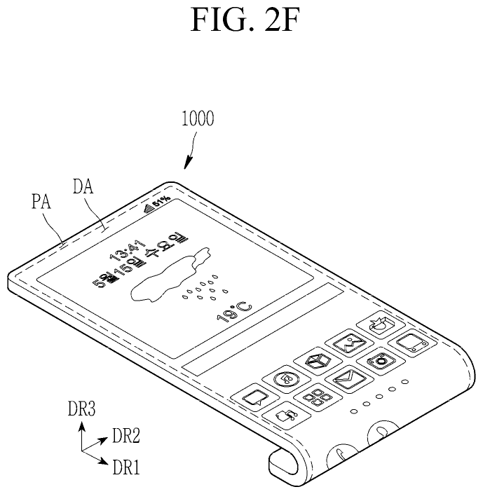

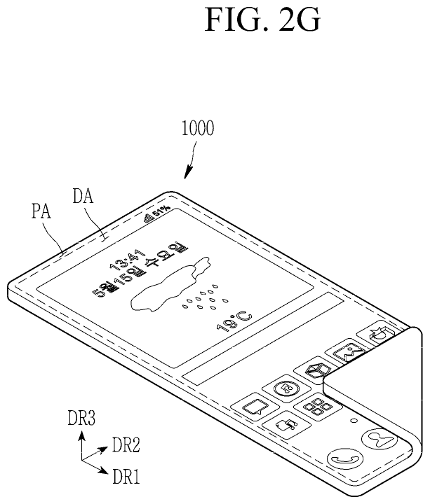

A display device according to an exemplary embodiment will now be described according to principles of the invention with reference to FIG. 1 to FIG. 2G. FIG. 1 illustrates a perspective view of a display device according to an exemplary embodiment, and FIG. 2A to FIG. 2G respectively illustrate perspective views of the display device illustrated in FIG. 1, which is folded, bent, or rolled.

First, referring to FIG. 1, a display device 1000 according to the illustrated exemplary embodiment may include a display area DA for displaying an image and a peripheral area PA positioned to surround the display area DA. The peripheral area PA may be an area where an image is not displayed, but exemplary embodiments of the invention are not limited thereto, and shapes of the display area DA and the peripheral area PA may be relatively changed. According to an exemplary embodiment, the peripheral area PA may be substantially omitted. In this specification, FIG. 1 illustrates icons of applications and a clock window, and the display area DA may have a generally quadrangular shape.

In the display area DA, a first surface S1 on which the image is displayed is substantially parallel to a surface defined by a first direction DR1 and a second direction DR2. A direction normal to the first surface S1, i.e., a thickness direction of the display device 1000, is represented as a third direction DR3. A front (or top) surface and a back (or bottom) surface of each of the members are separated by the third direction DR3. However, directions indicated by the first to third directions DR1, DR2, and DR3 may be converted to another direction as a relative concept. The display device 1000 according to an exemplary embodiment may be a flexible display device, but exemplary embodiments of the invention are not limited thereto, and the display device 1000 according to an exemplary embodiment may be a rigid display device.

The display device 1000 according to an exemplary embodiment may be a foldable display, a rollable display that can be rolled, or a bendable display that can be bent. The display device 1000 according to an exemplary embodiment may be used for large electronic devices such as televisions and monitors, and small and medium electronic devices such as portable phones, tablets, car navigation systems, game machines, and smart watches.

The display device 1000 may include a housing. The housing may be disposed around the outer circumference of the display device 1000 to accommodate components therein.

Hereinafter, referring to FIG. 1 and FIG. 2B, the display device 1000 according to the exemplary embodiment may be in-folded based on a bending axis BX parallel to the second direction DR2.

As the display device 1000 according to the exemplary embodiment is in-folded about the bending axis BX, the first surface S1 of the display device 1000 is folded about the bending axis BX parallel to the second direction DR2 so that two parts of the first surface S1 of the display device 1000 which are separated based on the bending axis BX can face each other and a rear surface opposite to the first surface S1 may be exposed to the outside.

Hereinafter, referring to FIG. 1 and FIG. 2B, the display device 1000 according to the exemplary embodiment may be out-folded based on a bending axis BX parallel to the second direction DR2. As the display device 1000 according to the exemplary embodiment is out-folded about the bending axis BX parallel to the second direction DR2, the first surface S1 of the display device 1000 is exposed to the outside, and the back surface opposite to the first surface S1 is folded about the bending axis BX parallel to the second direction DR2, so that opposite sides of the rear surface which is separated based on the bending axis BX face each other.

Referring to FIG. 1 and FIG. 2C, the display device 1000 according to the exemplary embodiment may be in-folded based on a bending axis BX parallel to the first direction DR1. As the display device 1000 according to the exemplary embodiment is in-folded about the bending axis BX parallel to the first direction DR1, two parts of the first surface S1 of the display device 1000 may be folded to face each other, and the rear surface opposite to the first surface S1 may be exposed to the outside.

Hereinafter, referring to FIG. 1 and FIG. 2D, the display device 1000 according to the exemplary embodiment may be out-folded based on the bending axis BX parallel to the first direction DR1. As the display device 1000 according to the exemplary embodiment is out-folded about the bending axis BX parallel to the first direction DR1, the first surface S1 of the display device 1000 is exposed to the outside, and the rear surface opposite to the first surface S1 is folded about the bending axis BX parallel to the first direction DR1, so that opposite sides of the rear surface which are separated based on the bending axis BX face each other.

Next, referring to FIG. 2E to FIG. 2G, the display device 1000 according to an exemplary embodiment may be folded or rolled in various ways. As illustrated in FIG. 2E, the display device 1000 according to an exemplary embodiment may be rolled or folded inward from an end portion thereof. Alternatively, as illustrated in FIG. 2F, the display device 1000 according to an exemplary embodiment may be rolled or folded outward from an end portion thereof. As illustrated in FIG. 2G, the display device 1000 according to an exemplary embodiment may be folded or rolled in a diagonal direction. FIG. 2A to FIG. 2G illustrate a rolling or folding method of the display device 1000 as examples, but exemplary embodiments of the invention are not limited thereto, and may be folded or rolled in various ways.

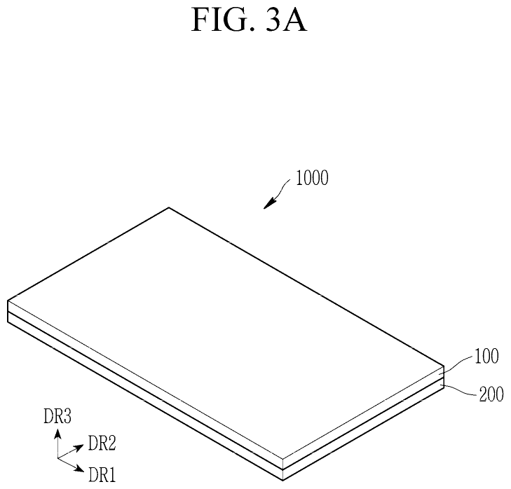

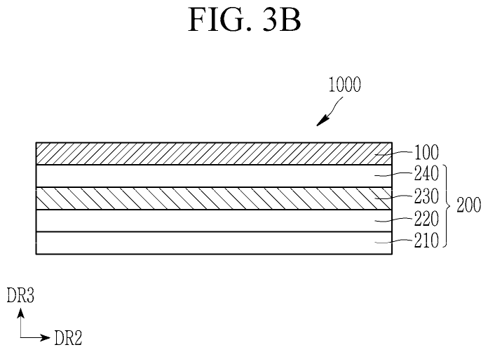

Hereinafter, a display device according to an exemplary embodiment will be described briefly with reference to FIG. 3A and FIG. 3B. FIG. 3A illustrates a perspective view of a display device according to an exemplary embodiment, and FIG. 3B illustrates a cross-sectional view of a display device according to an exemplary embodiment. FIG. 3B illustrates a cross-section defined by the second direction DR2 and the third direction DR3.

Referring to FIG. 3A and FIG. 3B, the display device 1000 according to an exemplary embodiment includes a window 100 and a display module 200 that overlaps the window 100. The display module 200 may include a protective film 210, a display panel 220, an optical member 230, and an input sensing member 240.

The display panel 220, the optical member 230, and the input sensing member 240 may be sequentially stacked on the protective film 210.

The display module 200 may include an upper surface and a rear surface opposite to the upper surface. The upper surface of the display module 200 may be a display surface for displaying an image. The display module 200 may generate an image to display the image in a direction of the window 100 contacting the upper surface of the display module 200.

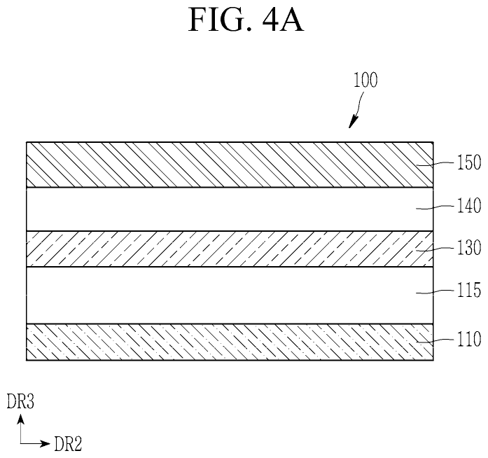

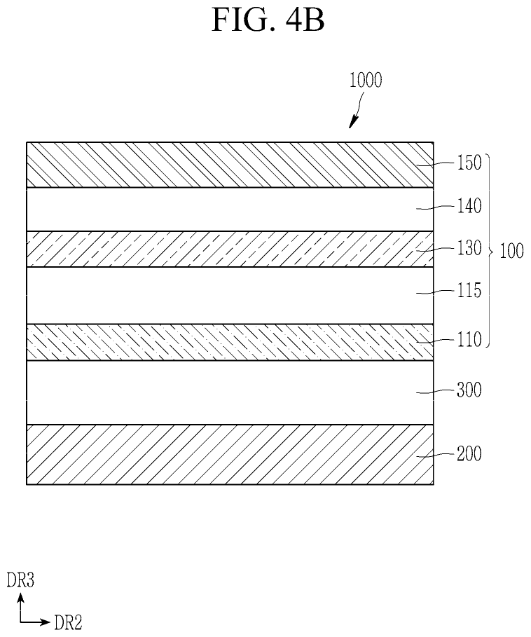

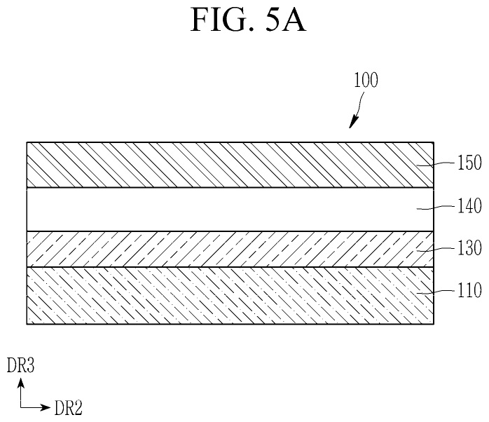

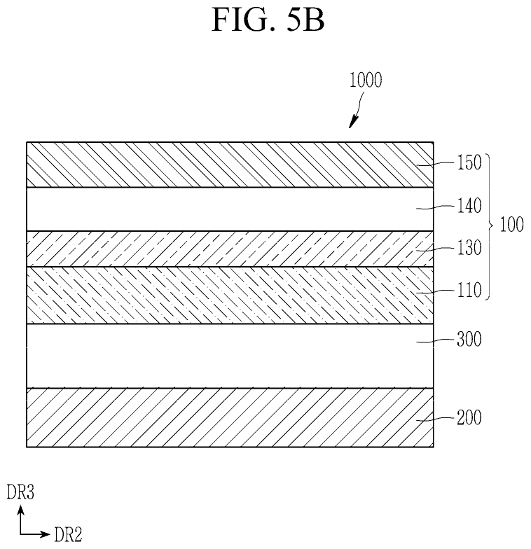

The window 100 may protect the display module 200 from external impact and provide an input surface to a user. The window 100 may include an external surface exposed to the outside. The first surface S1 (see FIG. 1) of the display device 1000 may correspond to the external surface of the window 100. A description of the window 100 will be made in more detail with reference to FIG. 4A to FIG. 5B.

The protective film 210 may be disposed under the display panel 220 to protect the display panel 220. Specifically, the protective film 210 may prevent external moisture from penetrating the display panel 220, and may absorb external impact. The protective film 210 may include a plastic film as a base layer. The protective film 210 may include a plastic that contains any one material selected from the group consisting of polyethersulphone (PES), polyacrylate, polyetherimide (PEI), polyethylene naphthalate (PEN), polyethylene terephthalate (PET), polyphenylene sulfide (PPS), polyallylate, polyimide (PI), polycarbonate (PC), poly(arylene ethersulfone), and a combination thereof.

The material constituting the protective film 210 is not limited to plastic resins, and may include an organic/inorganic composite material. The protective film 210 may include a porous organic layer and an inorganic material filled in pores of the organic layer. The protective film 210 may further include a film-functional layer formed on the plastic film. The film-functional layer may include a resin layer. The film-functional layer may be formed by a coating method.

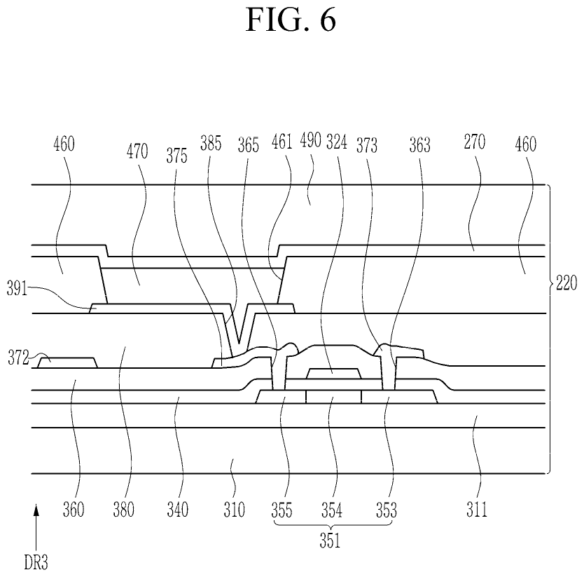

The display panel 220 may include a plurality of pixels, and may generate an image corresponding to inputted image data as is known in the art. An exemplary stacked structure of the pixels will be described below with reference to FIG. 6. The display panel 220 may generate an image, and may display the image in the thickness direction DR3 of the display device 1000. The display panel 220 may display the generated image in an upper direction in which the window 100 is disposed.

The optical member 230 optically converts incident light. The optical member 230 may reduce reflectance of light incident on the front surface, induce re-reflection of light incident on the rear surface, or improve transmittance of light incident on the rear surface. The optical member 230 may include at least one of a polarizing film, an anti-reflection film, a retardation film, and an anti-scattering film.

The input sensing member 240 may generate an electrical signal by sensing a touch applied from the outside. The touch includes various types of external input such as body contact/approach, contact/approach of a conductive object, light, heat, pressure, and the like. The input sensing member 240 may include sensors capable of sensing various inputs, such as a conductive sensor, an optical sensor, and a thermal sensor. The input sensing member 240 may sense a touch applied by a capacitive method or a pressure sensing method as is known in the art.

FIG. 3B illustrates an example in which the input sensing member 240 is disposed on the optical member 230, and the optical member 230 is disposed adjacent to the display panel 220, but exemplary embodiments of the invention are not limited thereto, and the relative position of each constituent element may be changed. For example, the input sensing member 240 may be disposed on the display panel 220, and the optical member 230 may be disposed on the input sensing member 240. The input sensing member 240 may be integrally formed on the display panel 220 by a continuous process. In this case, the input sensing member 240 may be referred to as an input sensing unit or an input sensing circuit.

The display device 1000 may further include a first adhesive layer, a second adhesive layer, a third adhesive layer, and a fourth adhesive layer. The first adhesive layer may couple the display panel 220 with the protective film 210, the second adhesive layer may couple the display panel 220 with the optical member 230, the third adhesive layer may couple the optical member 230 with the input sensing member 240, and the fourth adhesive layer may couple the input sensing member 240 with the window 100.

The display device 1000 may further include a frame structure to maintain the state illustrated in FIG. 2A to FIG. 2E. The frame structure may include a joint structure or a hinge structure.

Hereinafter, a window and a display device including the window constructed according to principles and exemplary embodiments of the invention will be described with reference to FIG. 4A to FIG. 5B. FIG. 4A illustrates a cross-sectional view of a window according to an exemplary embodiment, and FIG. 4B illustrates a cross-sectional view of a display device with a window according to the exemplary embodiment of FIG. 4A. FIG. 5A illustrates a cross-sectional view of a window according to an exemplary embodiment, and FIG. 5B illustrates a cross-sectional view of a display device with a window according to the exemplary embodiment of FIG. 5A.

First, referring to FIG. 4A, a window 100 according to the exemplary embodiment may include a first layer 110, an adhesive layer 115, a second layer 130, a third layer 140, and a hard coating layer 150. The window may further include a low reflection layer disposed on the hard coating layer 150. The low reflection layer may be provided in the form of a film or coating.

The first layer 110 may have a transmittance of about 90% or more for light in a visible wavelength band. The first layer 110 may include a material having a transmittance of about 90% or more for light in the visible wavelength band, and may include, e.g., polyurethane.

The thickness of the first layer 110 may be in a range of about 50 μm to about 400 μm, or in a range of about 150 μm to about 250 μm, for example. When the thickness of the first layer 110 is smaller than about 50 μm, impact absorption may not be easy, and when the thickness of the first layer 110 is greater than about 400 μm, the flexibility of the window may be reduced.

The first layer 110 may be provided in the window 100 in various forms, e.g., in the form of a film. The first layer 110 provided in the form of the film may be coupled with the second layer 130 through the adhesive layer 115.

The adhesive layer 115 may be disposed between the first layer 110 and the second layer 130. The adhesive layer 115 may adhere to the first layer 110 and the second layer 130.

The adhesive layer 115 may include an optically clear adhesive (OCA), an optically clear resin (OCR) or a pressure sensitive adhesive (PSA). The adhesive layer 115 may include a photocurable adhesive material or a thermocurable adhesive material.

The second layer 130 may have a transmittance of about 90% or more for light in the visible wavelength band, and a Young's modulus of the second layer 130 may be in a range of about 3 GPa to about 10 GPa. The second layer 130 may include a material having a Young's modulus of about 3 GPa to about 10 GPa with a transmittance of about 90% or more for light in the visible ray wavelength band. For example, the Young's modulus of the material included in the second layer 130 may be in a range of about 6 GPa to about 9 GPa.

For example, the second layer 130 may include at least one of polyethylene terephthalate, polyimide, polymethylmethacrylate, polycarbonate, polyethylenimine, polyphenylene sulfide, polyethylene naphthalate, and aramid.

The thickness of the second layer 130 may be about 150 μm or less. The second layer 130 may provide high elasticity to the window 100, and when the thickness exceeds about 150 μm, it may be difficult to provide appropriate elasticity to the window including the second layer.

The third layer 140 may be disposed between the second layer 130 and the hard coating layer 150. The third layer 140 may have a Young's modulus between about 1 GPa and about 10 GPa, and may have a transmittance of about 90% or more for light in the visible wavelength band. In other words, the third layer 140 may include a material having a Young's modulus between about 1 GPa and about 10 GPa and having a transmittance of about 90% or more for light in the visible ray wavelength band.

For example, the third layer 140 may include at least one of a photocurable acrylate, urethane acrylate, and a POSS compound (polyhedral oligomeric silsesquioxane compound).

The thickness of the third layer 140 may be in a range of about 30 μm to about 100 μm. When the thickness of the third layer 140 is less than about 30 μm, the impact resistance strength required for the window may be inadequate, and when the thickness of the third layer 140 is greater than about 100 μm, the desired flexibility for the window may be reduced.

The hard coating layer 150 may be disposed on the third layer 140. The hard coating layer 150 may be disposed at an outermost side of the window 100, and may be a layer capable of direct touch by the user.

The hard coating layer 150 may have a pencil hardness of about 4H or more and a transmittance of about 90% or more for light in the visible wavelength band. In other words, the hard coating layer 150 may include a material having a pencil hardness of about 4H or more and a transmittance of about 90% or more for light in the visible wavelength band.

For example, the hard coating layer 150 may include at least one of compounds represented by the following Chemical Formulas 1 to 15.

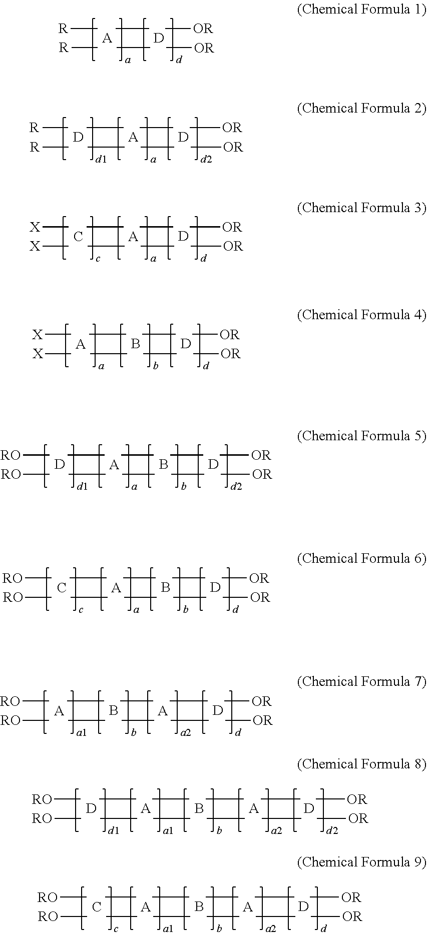

In Chemical Formula 1 to Chemical Formula 9, A indicates

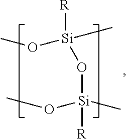

B indicates

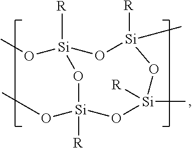

C indicates

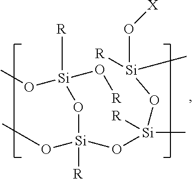

D indicates

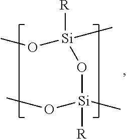

X independently indicates R or —[(SiO_{3/2}R)₂ₙ₊₄O], and R independently indicates hydrogen, heavy hydrogen, a halogen, an amine group, an epoxy group, a cyclohexyl epoxy group, an acrylic group, a methacrylic group, a thiol group, an isocyanate group, a nitrile group, a nitro group, a phenyl group, a C1 to C12 alkyl group, a C2-C12 alkenyl group, a C1-C40 alkoxy group, a C3-C12 cycloalkyl group, a C3-C12 heterocycloalkyl group, a C6-C12 aryl group, a C3-C12 heteroaryl group, a C3 to C12 aralkyl group, a C3 to C12 aryloxy group, and a C3 to C12 arylcyol group, wherein the phenyl group includes substituted or unsubstituted hydrogen, heavy hydrogen, a halogen, an amine group, an epoxy group, a cyclohexyl epoxy group, an acryl group, a methacryl, a thiol group, an isocyanate group, a nitrile group, or a nitro group, and each of a, a1, a2, b, c, d, d1, and d2 indicates an integer between 1 and 1000 and n is an integer of 1 to 100;

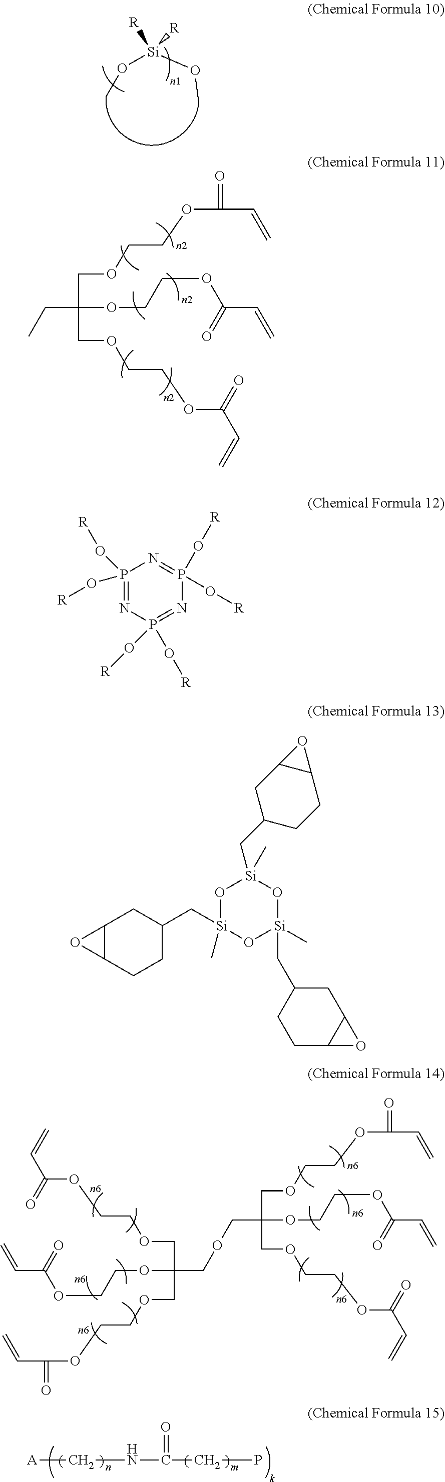

n1 in Chemical Formula 10 indicates an integer between 1 and 20, n2 in Chemical Formula 11 indicates an integer between 1 and 5, and R in Chemical Formulas 10 and 12 indicates any one selected from among

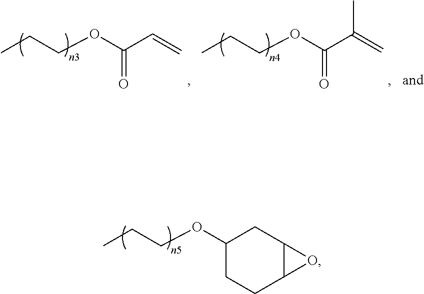

each of n3, n4, and n5 in R indicates an integer between 1 and 20, and n6 in Chemical Formula 14 indicates an integer between 1 and 20.

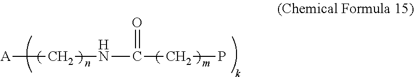

In Chemical Formula 15, each of k, n, and m indicates an integer between 1 and 12, A indicates an aliphatic compound, an aromatic compound, a condensed ring compound, a linear hydrocarbon compound, or a branched hydrocarbon compound, and P may include one of an acrylate group, a methacrylate group, an epoxy group, and a vinyl group. In this case, P may be a reactant capable of polymerization by heat or light.

Referring to FIG. 4B, the window 100 described with reference to FIG. 4A may be attached to the display module 200. A detailed description of window 100 will be omitted to avoid redundancy.

An adhesive layer 300 may be disposed between the window 100 and the display module 200. The adhesive layer 300 may include an optically clear adhesive (OCA), an optically clear resin (OCR), or a pressure sensitive adhesive (PSA). The adhesive layer 300 may include a photocurable adhesive material or a thermocurable adhesive material.

The display module 200 may be the same as the display module 200 described above with reference to FIG. 3A and FIG. 3B, and according to an exemplary embodiment, at least one of the protective film 210, the optical member 230, and the input sensing member 240 may be omitted. Hereinafter, a detailed description thereof will be omitted to avoid redundancy.

Next, the window 100 according to an exemplary embodiment will be described with reference to FIG. 5A. A description related to the same constituent element as the window described with reference to FIG. 4A will be omitted to avoid redundancy.

According to the exemplary embodiment, the first layer 110 may directly contact the second layer 130. The first layer 110 according to the exemplary embodiment may be coupled with the second layer 130 without a separate adhesive layer.

The first layer 110 may have a hardness of about 0.2 GPa or less and a transmittance of about 90% or more for light in the visible wavelength band. The first layer 110 may include a material having a hardness of about 0.2 GPa or less and a transmittance of about 90% or more for light in the visible wavelength band.

For example, the first layer 110 may include at least one of a photocurable acrylate, urethane acrylate, and a POSS compound (a polyhedral oligomeric silsesquioxane compound).

The thickness of the first layer 110 according to the exemplary embodiment may be greater than or equal to about 50 μm and less than or equal to about 400 μm. When the thickness of the first layer 110 is smaller than about 50 μm, impact absorption may not be easy, and when the thickness of the first layer 110 is greater than about 400 μm, the flexibility of the window may be reduced.

Unlike the window 100 of FIG. 4A, the window 100 of FIG. 5A does not include a separate adhesive layer that couples the first layer 110 and the second layer 130 with each other. The first layer 110 according to the exemplary embodiment of FIG. 5A may be formed by applying and curing a material forming the first layer 110 as an example, and thus a separate adhesive layer may not be required.

Referring to FIG. 5B, the window 100 described with reference to FIG. 5A may be attached to the display module 200. A detailed description of window 100 will be omitted to avoid redundancy.

A separate adhesive layer 300 may be disposed between the window 100 and the display module 200. The adhesive layer 300 may include an optically clear adhesive (OCA), an optically clear resin (OCR), or a pressure sensitive adhesive (PSA). The adhesive layer 300 may include a photocurable adhesive material or a thermocurable adhesive material.

The display module 200 may be the same as the display module 200 described above with reference to FIG. 3A and FIG. 3B, and according to an exemplary embodiment, at least one of the protective film 210, the optical member 230, and the input sensing member 240 may be omitted. Hereinafter, a detailed description thereof will be omitted to avoid redundancy.

Hereinafter, a portion of one representative pixel included in a display panel will be described with reference to FIG. 6. FIG. 6 illustrates a cross-sectional view of a portion of a pixel included in a display device according to an exemplary embodiment.

The display panel 220 according to the illustrated exemplary embodiment includes a buffer layer 311 disposed on a substrate 310. The buffer layer 311 may overlap a front surface of the substrate 310. The buffer layer 311 may be made of an organic material such as a silicon oxide (SiOₓ), a silicon nitride (SiNₓ), or the like. The buffer layer 311 may be a single layer or a plurality of layers.

The buffer layer 311 may flatten a surface of the substrate 310, or may prevent the diffusion of impurities which deteriorate characteristics of a semiconductor layer 351 which will be described later, and may prevent penetration of moisture or the like. According to an exemplary embodiment, the buffer layer 311 may be omitted.

The semiconductor layer 351 of the thin film transistor is disposed on the buffer layer 311. The semiconductor layer 351 includes a channel region 354, and a source region 353 and a drain region 355 disposed at opposite sides of the channel region 354 and doped with impurities. The semiconductor layer 351 may include polysilicon, amorphous silicon, or an oxide semiconductor.

A gate insulating layer 340 is disposed on the semiconductor layer 351. The gate insulating layer 340 may be disposed to overlap a front surface the substrate 310. The gate insulating layer 340 may include an inorganic insulating material such as a silicon oxide (SiOₓ), a silicon nitride (SiNₓ), and the like.

A gate conductor including a gate electrode 324 of the thin film transistor is disposed on the gate insulating layer 340. The gate electrode 324 may overlap the channel region 354 of the semiconductor layer 351.

A first insulating layer 360 including an inorganic insulating material or an organic insulating material is disposed on the gate electrode 324.

A data conductor including a source electrode 373 and a drain electrode 375 of a thin film transistor, a driving voltage line 372, and the like is disposed on the first insulating layer 360. The source electrode 373 and the drain electrode 375 may be connected to the source region 353 and the drain region 355 of the semiconductor layer 351 through contact holes 363 and 365 of the first insulating layer 360 and the gate insulating layer 340, respectively. The driving voltage line 372 according to the exemplary embodiment may receive a driving voltage ELVDD.

The gate electrode 324, the source electrode 373, and the drain electrode 375 constitute a thin film transistor together with the semiconductor layer 351. The thin film transistor illustrated herein may be a driving transistor included in one pixel of a light emitting diode display. The illustrated thin film transistor may be referred to as a top-gate transistor because the gate electrode 324 is disposed above the semiconductor layer 351. The structure of the transistor is not limited thereto, and may be variously changed. For example, it may be a bottom-gate transistor in which the gate electrode is disposed below the semiconductor layer.

A second insulating layer 380 is disposed on the first insulating layer 360 and the data conductor. The second insulating layer 380 may serve to eliminate steps and perform planarization to increase luminous efficiency of the light emitting diode display to be formed thereon. The second insulating layer 380 may cover the thin film transistor while overlapping the thin film transistor.

A pixel electrode 391 is disposed on the second insulating layer 380. The pixel electrode 391 may be connected to the drain electrode 375 of the thin film transistor through a contact hole 385 of the second insulating layer 380.

A third insulating layer 460 is disposed on the second insulating layer 380 and the pixel electrode 391. The third insulating layer 460 may overlap a portion of the pixel electrode 391. The third insulating layer 460 has an opening 461 overlapping a portion of the pixel electrode 391.

The third insulating layer 460 may be an organic insulating material such as polyimide, polyacrylate, or polyamide, or may include an inorganic insulating material.

An emission layer 470 is disposed in the pixel electrode 391. The emission layer 470 includes a light emitting region. The emission layer 470 may additionally include at least one of a hole injection region, a hole transport region, an electron injection region, and an electron transport region.

The emission layer 470 may include an organic material that uniquely emits light of a basic color such as red, green, and blue. Alternatively, the emission layer 470 may have a structure in which a plurality of organic materials emitting light of different colors is stacked. Alternatively, the emission layer 470 may an inorganic material that emits light such as red, green, and blue.

A common electrode 270 that transfers a common voltage (e.g., a second power supply voltage and an ELVSS voltage) is positioned on the emission layer 470 and the third insulating layer 460.

The pixel electrode 391, the emission layer 470, and the common electrode 270 of each pixel constitute a light-emitting element, which is a light emitting diode (LED). The pixel electrode 391 may be an anode which is a hole injection electrode, and the common electrode 270 may be a cathode which is an electron injection electrode. Conversely, the pixel electrode 391 may be a cathode, and the common electrode 270 may be an anode. When holes and electrons are injected from the pixel electrode 391 and the common electrode 270 into the emission layer 470, excitons formed by combining the injected holes and electrons are emitted when they fall from an excited state to a ground state.

An encapsulation layer 490 may be disposed on the common electrode 270. The encapsulation layer 490 may include a single inorganic layer, a single organic layer, a plurality of inorganic layers, or a plurality of organic layers, or may include a structure in which inorganic layers and organic layers are alternately stacked. According to an exemplary embodiment, the encapsulation layer 490 may include a structure in which an organic layer is stacked between two inorganic layers.

Hereinafter, a display device according to an exemplary embodiment will described with reference to Table 1.

According to the exemplary embodiment, the display device includes a structure in which a display panel, an adhesive layer, a first layer including a transparent polyurethane, an adhesive layer, a second layer including a transparent aramid, a third layer including a tetrafunctional acrylate, and a hard coating layer including a POSS-based compound are stacked in that order.

TABLE 1

| Evaluation item | Evaluation condition | Evaluation result |
|---|---|---|
| Folding evaluation | 200,000 evaluations with | No cracks or breaks |
| | a 1 mm radius of curvature | |
| Impact resistance | Big pen drop | No defect up to 10 cm |
| evaluation | | |
| Wear resistance | Evaluation of steel wool | No scratch up to 200 |
| evaluation | at 1.5 kg | rubs |

Folding evaluation, impact resistance evaluation, and wear resistance evaluation were performed on the display device according to the exemplary embodiment. The folding evaluation was performed by folding the display device 200,000 times with a curvature of a radius of 1 mm. The folding evaluation according to the exemplary embodiment confirmed that cracks and breaks did not occur. The impact resistance evaluation was performed by dropping a big pen on the display device and adjusting a height of the big pen to check the height of the big pen that caused a defect thereon. As a result of performing the impact resistance evaluation according to the exemplary embodiment, it was confirmed that no defect occurred until the big pen dropped from 10 cm. The wear resistance evaluation was performed by rubbing a surface of the window with a steel wool under a predetermined load to check whether scratches had occurred thereon. As a result of performing the wear resistance evaluation with a load of 1.5 kg according to the exemplary embodiment, it was confirmed that no scratch occurred up to 200 rubs. As described above, it can be seen that the window according to the exemplary embodiment not only has flexibility but also has excellent impact resistance and wear resistance characteristics.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A window for a display device, the window comprising:
a first layer comprising polyurethane;
a second layer disposed on the first layer and the second layer having a Young's modulus in a range of about 3 GPa to about 10 GPa;
a third layer disposed on the second layer; and
a hard coating layer disposed on the third layer.

2. The window of claim 1, wherein the first layer has a thickness of about 50 μm to about 400 μm.

3. The window of claim 1, further comprising an adhesive layer disposed between the first layer and the second layer.

4. The window of claim 3, wherein the second layer includes at least one of polyethylene terephthalate, polyimide, polymethylmethacrylate, polycarbonate, polyethylenimine, polyphenylene sulfide, polyethylene naphthalate, and aramid.

5. The window of claim 1, wherein a Young's modulus of the third layer is between about 1 GPa and about 10 GPa, and a transmittance of the third layer for light in a visible wavelength band is about 90% or more.

6. The window of claim 5, wherein the third layer includes at least one of a photocurable acrylate, urethane acrylate, and a polyhedral oligomeric silsesquioxane compound.

7. The window of claim 5, wherein the third layer has a thickness of about 30 μm to about 100 μm.

8. The window of claim 1, wherein the hard coating layer has a pencil hardness of about 4H or more, and a transmittance of the hard coating layer for light in a visible wavelength band is about 90% or more.

9. The window of claim 8, wherein the hard coating layer includes at least one of compounds represented by Chemical Formula 1 to Chemical Formula 15: 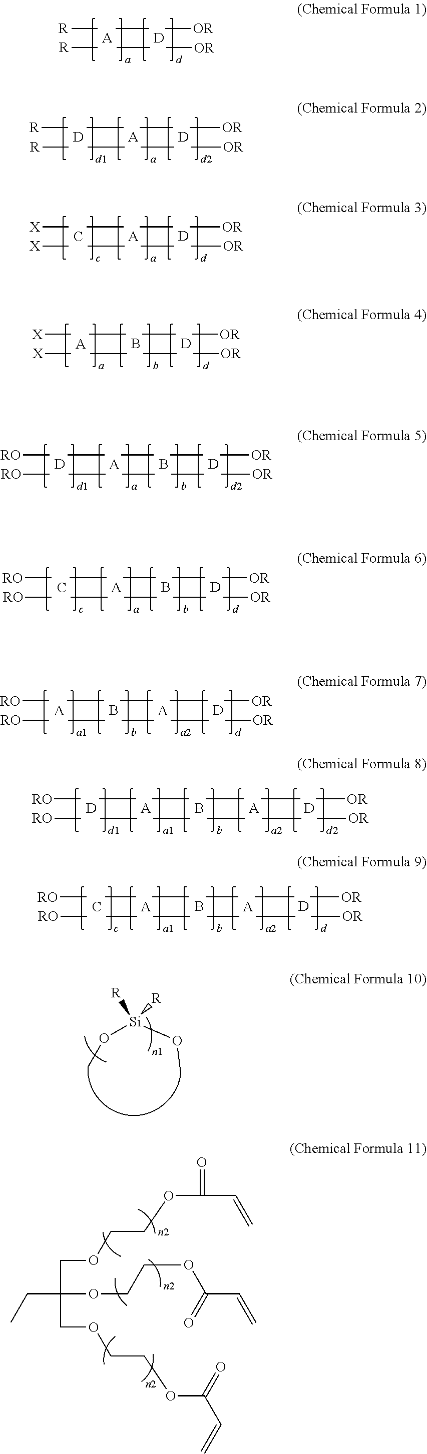 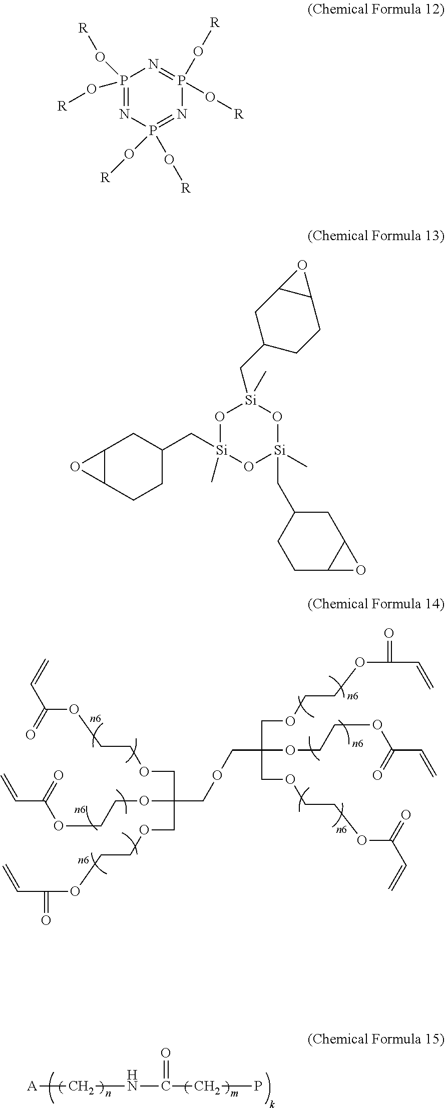
wherein, in Chemical Formula 1 to Chemical Formula 9, A indicates 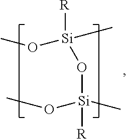
B indicates 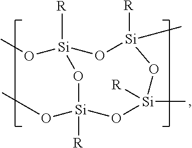
C indicates 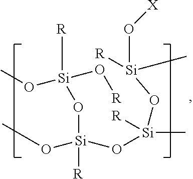
D indicates 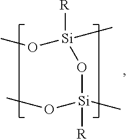
X independently indicates R or —[(SiO_{3/2}R)₂ₙ₊₄O], and R independently indicates hydrogen, heavy hydrogen, a halogen, an amine group, an epoxy group, a cyclohexyl epoxy group, an acrylic group, a methacrylic group, a thiol group, an isocyanate group, a nitrile group, a nitro group, a phenyl group, a C1 to C12 alkyl group, a C2-C12 alkenyl group, a C1-C40 alkoxy group, a C3-C12 cycloalkyl group, a C3-C12 heterocycloalkyl group, a C6-C12 aryl group, a C3-C12 heteroaryl group, a C3 to C12 aralkyl group, a C3 to C12 aryloxy group, and a C3 to C12 arylcyol group, wherein the phenyl group includes substituted or unsubstituted hydrogen, heavy hydrogen, a halogen, an amine group, an epoxy group, a cyclohexyl epoxy group, an acryl group, a methacryl, a thiol group, an isocyanate group, a nitrile group, or a nitro group, and each of a, a1, a2, b, c, d, d1, and d2 indicates an integer between 1 and 1000;
n is an integer of 1 to 100;
n1 in Chemical Formula 10 indicates an integer between 1 and 20, n2 in Chemical Formula 11 indicates an integer between 1 and 5, and R in Chemical Formulas 10 and 12 indicates any one selected from among 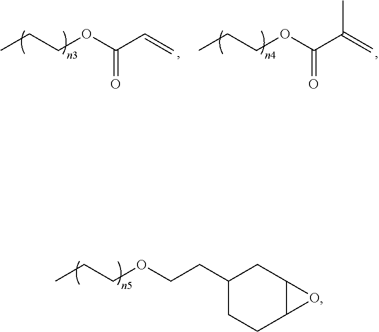
each of n3, n4, and n5 in R indicates an integer between 1 and 20, and n6 in Chemical Formula 14 indicates an integer between 1 and 20; and
in Chemical Formula 15, each of k, n, and m indicates an integer between 1 and 12, A indicates an aliphatic compound, an aromatic compound, a condensed ring compound, a linear hydrocarbon compound, or a branched hydrocarbon compound, and P includes one of an acrylate group, a methacrylate group, an epoxy group, and a vinyl group.

10. A window for a display device, the window comprising:
a first layer having a hardness of about 0.2 GPa or less and a transmittance of about 90% or more for light in a visible wavelength range;
a second layer disposed on the first layer, the second layer having a Young's modulus in a range of about 3 GPa to about 10 GPa;
a third layer disposed on the second layer; and
a hard coating layer disposed on the third layer.

11. The window of claim 10, wherein
the first layer includes at least one of a photocurable acrylate, urethane acrylate, and a polyhedral oligomeric silsesquioxane compound.

12. The window of claim 10, wherein the first layer and the second layer are in direct contact with each other.

13. A display device comprising:
a first layer having a transmittance for light in a visible wavelength band greater than about 90%;
a second layer disposed on the first layer, the second layer having a Young's modulus in a range of about 3 GPa to about 10 GPa;
a third layer disposed on the second layer, the third layer having a Young's modulus between about 1 GPa and about 10 GPa; and
a hard coating layer disposed on the third layer

14. The display device of claim 13, wherein the first layer comprises polyurethane.

15. The display device of claim 14, wherein the first layer has a thickness of about 50 μm to about 400 μm.

16. The display device of claim 13, wherein the first layer has a hardness of about 0.2 GPa or less.

17. The display device of claim 16, wherein the first layer comprises at least one of a photocurable acrylate, urethane acrylate, and a polyhedral oligomeric silsesquioxane compound.

18. The display device of claim 16, wherein the first layer and the second layer are in direct contact with each other.

19. The display device of claim 13, wherein the third layer comprises at least one of a photocurable acrylate, urethane acrylate, and a polyhedral oligomeric silsesquioxane compound.

20. The display device of claim 13, wherein the hard coating layer has a pencil hardness of about 4H or more and a transmittance of about 90% or more for light in a visible wavelength band.
